(19) United States
(12) Patent Application Publication
(10) Pub. No.: US 2017/0090350 A1
(43) Pub. Date: Mar. 30, 2017

(54) METHOD FOR REMANUFACTURING TONER CARTRIDGES

(71) Applicant: FLO-TECH, LLC, Middletown, CT (US)

(72) Inventor: Peter Vincent Massaro, JR., West Haven, CT (US)

(73) Assignee: FLO-TECH, LLC, Middletown, CT (US)

(21) Appl. No.: 15/375,819

(22) Filed: Dec. 12, 2016

Related U.S. Application Data
(63) Continuation-in-part of application No. 14/658,559, filed on Mar. 16, 2015, now abandoned.
Application No. 14/658,559 is a continuation of application No. 14/230,724, filed on Mar. 31, 2014, now Pat. No. 9,069,290.
(60) Provisional application No. 61/814,996, filed on Apr. 23, 2013.

(51) Int. Cl. G03G 15/08

(52) U.S. Cl. CPC G03G 15/0894; G03G 15/0886

(57) ABSTRACT

A method for remanufacturing toner cartridges comprises the steps of placing a toner cartridge shell in a jig; tapping at least one of a wiper blade screw hole and a doctor blade screw hole in the toner cartridge shell; the tapping step comprising cutting new threading into at least one wiper blade screw hole and at least one doctor blade screw hole; and inserting a machine screw insert into each of the at least one wiper blade screw hole and the doctor blade screw hole.

### CROSS-REFERENCE TO RELATED APPLICATIONS

The current application is a continuation-in-part of the continuation application U.S. Ser. No. 14/658,559, filed Mar. 16, 2015, which is a continuation of U.S. Ser. No. 14/230,724, filed Mar. 31, 2014, and entitled METHOD FOR REMANUFACTURING TONER CARTRIDGES and which claims priority to the U.S. Provisional Patent application Ser. No. 61/814,996 filed on Apr. 23, 2013.

### FIELD OF THE INVENTION

The present invention relates generally to laser printer. More specifically, the present invention is a method for remanufacturing empty laser printer toner cartridges that eliminates stripped plastic screw holes causing cartridge damage.

### BACKGROUND

The consumable component of modern xerographic laser printers is the toner cartridge. Toner cartridges are similar to ink cartridges used by inkjet printers but contain toner powder that is used to form images on paper. During the printing process, the photoreceptor of the laser printer is positively charged and an electrostatic image is formed on the surface of the photoreceptor. The electrostatic image is formed by discharging portions of the photoreceptor surface to form the image. These portions of the photoreceptor surface are negatively discharged. The toner powder is electrostatically drawn from the cartridge and transferred to paper. Because the toner powder features a positive charge, the particles are drawn to the negatively discharged portions of the photoreceptor, forming a toner image on the photoreceptor surface. The toner powder is repelled from the positively charged portions of the photoreceptor. Following the application of the toner powder, the photoreceptor drum is rolled over a sheet of paper. The sheet of paper is given a negative charge that is stronger than the negative charge of the photoreceptor drum. This allows the toner powder to transfer from the photoreceptor drum to the paper. The toner powder is finally heated, melted, and rolled onto the paper by the fuser.

Toner cartridges are typically very expensive which has led to the emergence of an industry for remanufactured toner cartridges. Remanufactured toner cartridges are recycled original toner cartridges that have undergone a number of quality control processes. Used toner cartridges are disassembled and cleaned before the toner hopper is refilled with toner powder. The toner hopper is sealed to prevent the toner cartridge from leaking during use. The toner cartridge is reassembled following the cleaning, refilling, and sealing processes. A common problem of remanufactured toner cartridges is stripped plastic in threaded screw holes. Repeated disassembly and reassembly of the toner cartridges results in stripped threading in the screw holes. The problem is exacerbated by the vibrations experienced by the toner cartridges during use. Unreliable fasteners can lead to problems with the toner cartridge and the laser printer as well. The present invention seeks to address the aforementioned issue and provide a practical, reliable, and repeatable solution.

Therefore it is the object of the present invention to provide a method for remanufacturing empty laser printer toner cartridges that eliminates stripped plastic screw holes commonly encountered during the remanufacturing process and during use. In the preferred embodiment of the present invention, a machine screw insert is slotted into all plastic screw holes of a toner cartridge hopper shell and waste bin shell. The machine screw is attached to a mandrel and inserted into a hole that is threaded by a tap. Each machine screw insert is adhesively held in place within a plastic screw hole. This allows machine screws to be used during the toner cartridge reassembly process without stripping the plastic threading of the screw holes. After the machine screw inserts have been installed, the toner cartridges may be reliably remanufactured multiple times.

### SUMMARY

In accordance with the present disclosure, there is provided a method for remanufacturing toner cartridges comprises the steps of placing a toner cartridge shell in a jig; tapping at least one of a wiper blade screw hole and a doctor blade screw hole in the toner cartridge shell; the tapping step comprising cutting new threading into at least one wiper blade screw hole and at least one doctor blade screw hole; and inserting a machine screw insert into each of the at least one wiper blade screw hole and doctor blade screw hole.

In another and alternative embodiment, the method further comprises removing a plurality of screws from the at least one wiper blade screw hole and the at least one doctor blade screw hole prior to the tapping step.

In another and alternative embodiment, the inserting step comprises inserting a machine screw insert having a threaded outer surface and a threaded inner surface.

In another and alternative embodiment, the method further comprises interfacing the threaded outer surface of the machine screw insert with the new threading in one of the at least one wiper blade screw hole and the at least one doctor blade screw hole.

In another and alternative embodiment, the method further comprises interfacing the threaded inner surface with a screw.

In another and alternative embodiment, the method further comprises applying an adhesive to the machine screw insert to secure the machine screw insert into at least one of the at least one wiper blade screw hole and the at least one doctor blade screw hole.

In another and alternative embodiment, the machine screw inserting step comprises attaching a machine mandrel to a drilling machine and attaching the machine screw insert to the machine mandrel.

In another and alternative embodiment, the method further comprises activating the machine mandrel to insert the machine screw insert into one of the at least one wiper blade screw hole and the at least one doctor blade screw hole.

In another and alternative embodiment, the activating step comprises spinning the machine mandrel in a first direction in order to insert the machine screw insert into the one of the at least one wiper blade screw hole and the at least one doctor blade screw hole and then spinning the machine mandrel in a second direction opposite the first direction to raise the machine mandrel out of the at least one wiper blade screw hole and at least one doctor blade screw hole while the machine screw insert is retained in the one of the at least one wiper blade screw hole and the at least one doctor blade screw hole.

In accordance with the present disclosure, there is provided a toner cartridge comprising a toner cartridge shell; the toner cartridge shell having at least one wiper blade screw hole and at least one doctor blade screw hole; and at least one machine screw insert in the at least one wiper blade screw hole and the at least one doctor blade screw hole.

In another and alternative embodiment, the at least one machine screw insert comprises a threaded outer surface for contacting the at least one wiper blade screw hole and the at least one doctor blade screw hole and a threaded inner surface.

In another and alternative embodiment, there is a screw contacting the threaded inner surface.

In another and alternative embodiment, there is a plurality of machine screw inserts and one of the plurality of machine screw inserts being located in each of the at least one wiper blade screw hole and the at least one doctor blade screw hole.

In another and alternative embodiment, there is an adhesive applied to the at least one machine screw insert for retaining the at least one machine screw insert in the at least one wiper blade screw hole and the at least one doctor blade screw hole.

In another and alternative embodiment, there is a toner filling the toner cartridge and a cover secured to the toner cartridge shell by an outer screw attached to another at least one machine screw insert.

In accordance with the present disclosure, there is provided a system for remanufacturing toner cartridges comprises a toner cartridge shell having at least one wiper blade screw hole and at least one doctor blade screw hole; a jig compatible with the toner cartridge shell; and at least one machine screw insert for placement in at least one of the at least one wiper blade screw hole and the at least one doctor blade screw hole.

In another and alternative embodiment, there is a drill; and a tap attached to the drill, whereby the drill is operated to tap the at least one wiper blade screw hole and the at least one doctor blade screw hole.

In another and alternative embodiment, the system further comprises a machine mandrel attached to the drill; and the at least one machine screw insert being attached to the machine mandrel, whereby the machine mandrel is operated to insert the at least one machine screw insert into at least one of the at least one wiper blade screw hole and the at least one doctor blade screw hole.

In another and alternative embodiment, the system further comprises an adhesive for securing the at least one machine screw insert in the at least one wiper blade screw hole and the at least one doctor blade screw hole, the adhesive being applied to the at least one machine screw insert.

In another and alternative embodiment, the system further comprises a plurality of machine screw inserts; and one of the plurality of machine screw inserts being inserted into each one of the at least one wiper blade screw hole and the at least one doctor blade screw hole.

### BRIEF DESCRIPTION OF THE DRAWINGS

FIG. 1 is a flowchart showing the basic steps for carrying out the method of the present invention;

FIG. 2 is a flowchart thereof showing expanded steps for inserting the plurality of machine screw inserts into the plurality of screw holes.

FIG. 3 is a flowchart including additional steps for carrying out the method of the present invention;

FIG. 4 is a flowchart thereof expanding on the step of removing the plurality of screws from the plurality of screw holes in order to disassemble the toner cartridge;

FIG. 5 is a flowchart thereof expanding on the step of inserting the plurality of screws into the plurality screw holes in order to reassemble the toner cartridge;

FIG. 6 is a flowchart thereof detailing the rotation speeds of the machine mandrel.

FIG. 7 is a diagram depicting the selection of the compatible jig from the plurality of jigs, and the insertion of the toner cartridge shell into the compatible jig.

FIG. 8 is a diagram depicting the selection of the at least one desired tap from the plurality of taps.

FIG. 9 is a front sectional view of a machine screw insert;

FIG. 10 is a front elevational view thereof showing the adhesive applied to the machine screw insert.

FIG. 11 is a diagram depicting a specific hole being aligned with the machine mandrel.

FIG. 12 is a diagram depicting the machine screw insert being inserted into the specific hole 13, wherein the machine mandrel is spun in a first direction.

FIG. 13 is a perspective view for illustrating mounting and demounting of the cartridge with respect to an image forming apparatus main assembly in an exemplary embodiment.

FIG. 14 is an exploded view depicting the cartridge wastebin with machine screw insert being inserted into the wiper blade screw hole.

FIG. 15 is a diagram depicting the cartridge wastebin with the desired tap being inserted into the wiper blade screw hole.

FIG. 16 is an exploded view depicting the cartridge hopper with machine screw insert being inserted into the doctor blade screw hole.

FIG. 17 is a diagram depicting the cartridge hopper with the desired tap being inserted into the doctor blade screw hole.

### DETAILED DESCRIPTION

All illustrations of the drawings are for the purpose of describing selected versions of the present invention and are not intended to limit the scope of the present invention.

The present invention is a method for remanufacturing empty laser printer toner cartridges that maintains the structural integrity of the screw holes used when disassembling and reassembling the cartridges. In the preferred embodiment of the present invention, a plurality of machine screw inserts 41 is slotted into a plurality of screw holes 13 of a toner cartridge shell 11 in order to prevent damage to the plurality of screw holes 13 from repeated disassembly and reassembly of a toner cartridge 10.

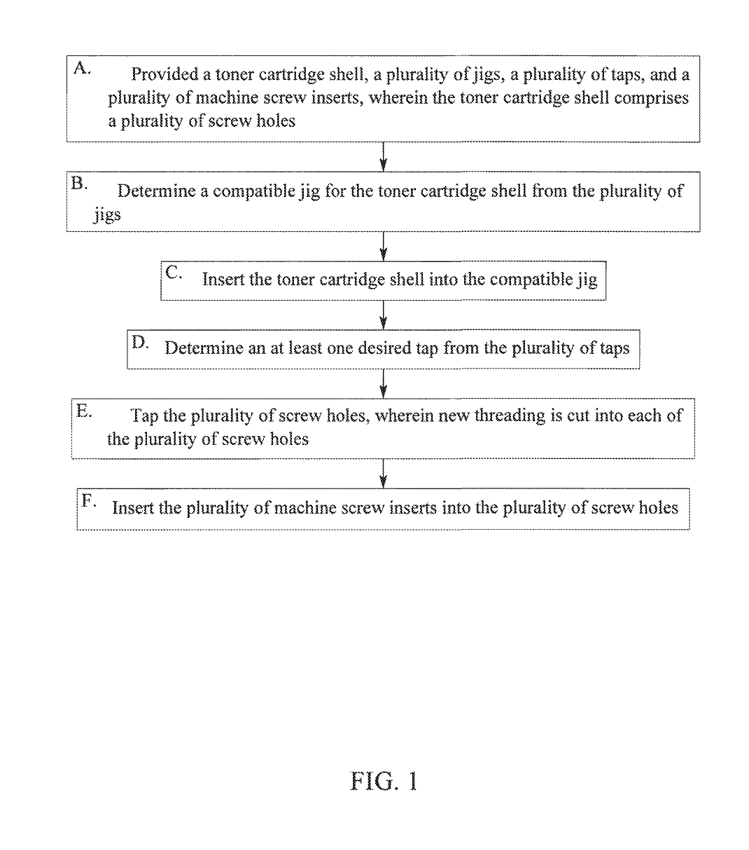

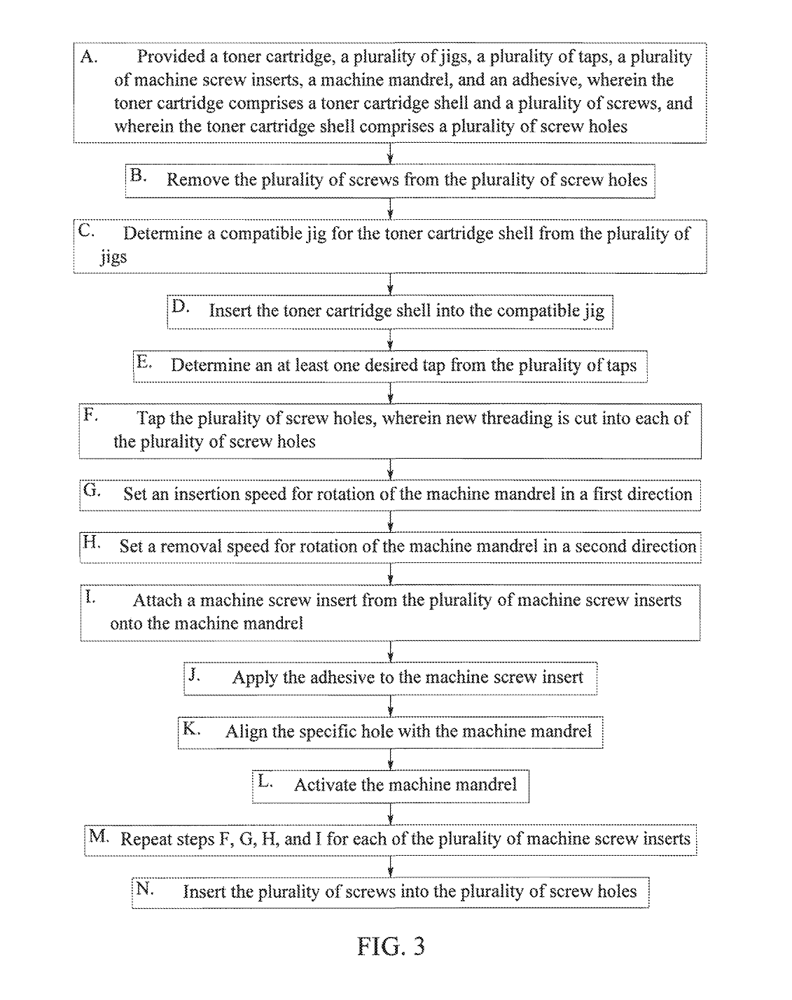

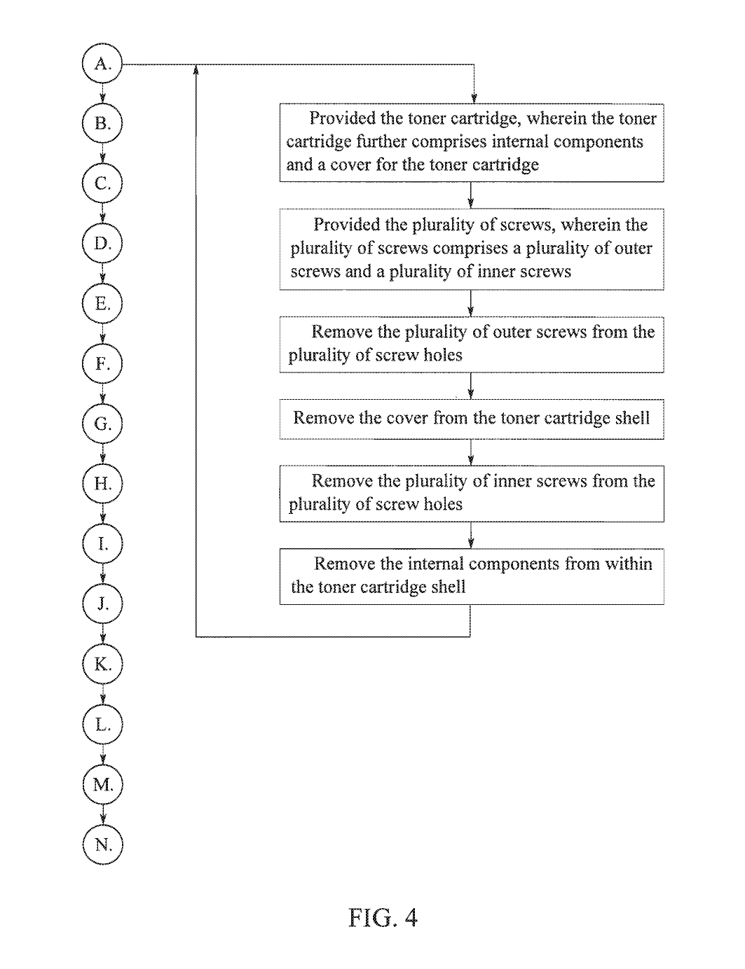

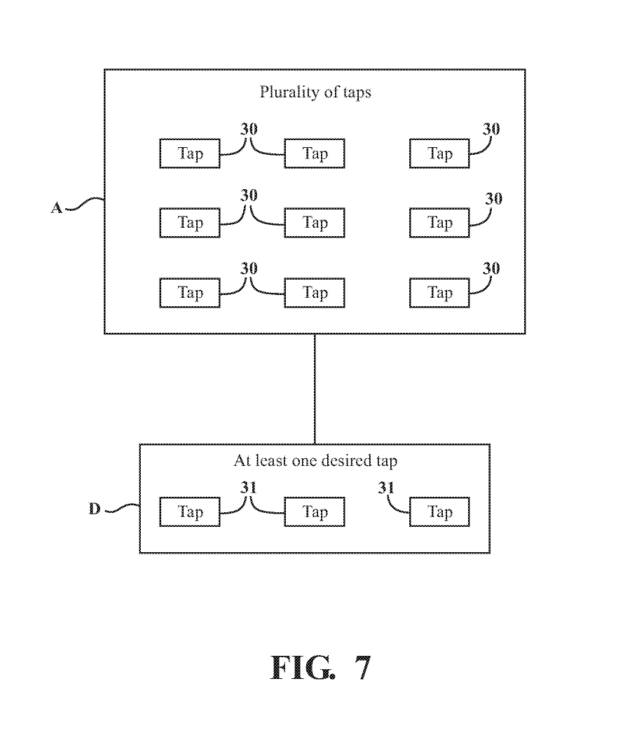

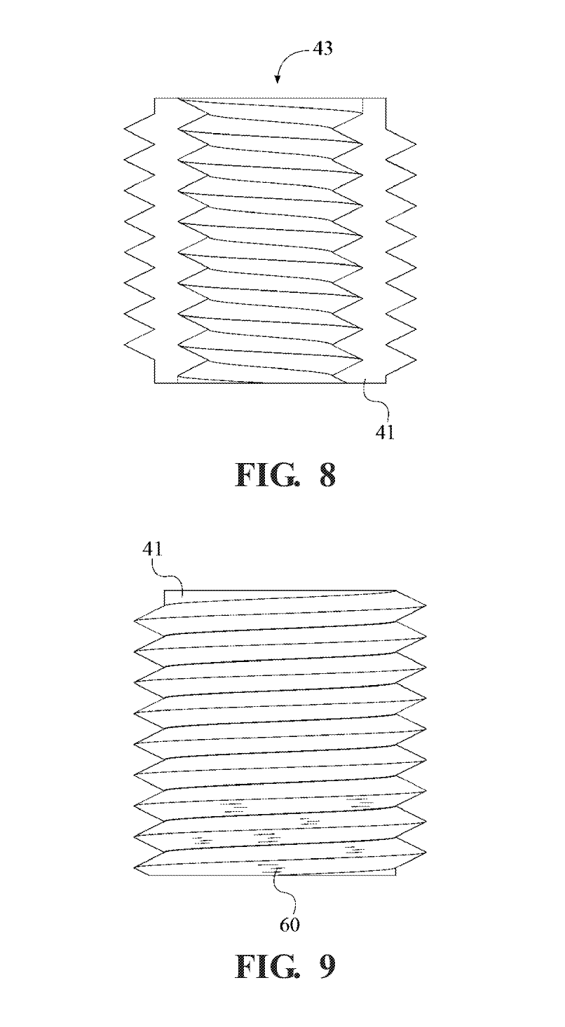

In reference to FIG. 3-4, in order to install the plurality of machine screw inserts 41, the toner cartridge 10, comprising the toner cartridge shell 11, a cover, internal components, and a plurality of screws, must first be disassembled. The plurality of screws is removed from the plurality of screw holes 13 in order to disassemble the toner cartridge 10. The plurality of screws comprises a plurality of outer screws and a plurality of inner screws. The plurality of outer screws is removed from the plurality of screw holes 13, such that the cover can then be removed from the toner cartridge shell 11. Once the cover is removed, the plurality of inner screws retaining the internal components within the toner cartridge shell 11 is removed from the plurality of screw holes 13. Each of the internal components is then removed from the toner cartridge shell 11. The internal components may comprise any known toner cartridge 10 components, such as a primary charge roller, a drum, a wiper blade, a toner roller, etc. The toner cartridge shell 11 is then cleaned following removal of the internal components. In reference to FIG. 1 and FIG. 7, in order to carry out the method of the present invention, a plurality of jigs 20 is provided in order to accommodate different models of the toner cartridge 10. By observing the model of the toner cartridge 10, a compatible jig 21 for the toner cartridge shell 11 is determined from the plurality of jigs 20. The compatible jig 21 acts to hold the toner cartridge shell 11 in place, while allowing the toner cartridge shell 11 to be aligned with a machine drill, such that the plurality of screw holes 13 can be accurately drilled. In reference to FIG. 8, a plurality of taps 30 is also provided in order to accommodate for various diameters in the plurality of screw holes 13. From observing the plurality of screw holes 13 of the toner cartridge shell 11, at least one desired tap 31 is determined from the plurality of taps 30.

Once the at least one tap is selected, the at least one tap is attached to the machine drill. Each of the plurality of screw holes 13 is then tapped using the machine drill, wherein the at least one tap is lowered into each of the plurality of screw holes 13 in order to create new threading within each of the plurality of screw holes 13. The drilling machine depth is preset according to the compatible jig 21 and the plurality of screw holes 13. In the preferred embodiment of the present invention, the drilling machine is operated at a rotation speed between 300 and 500 revolutions per minute. Additionally, the drilling machine is operated at a low torque in order to ensure that the each of the plurality of screw holes 13 is correctly tapped. In the preferred embodiment of the present invention, the drilling machine is operated in a torque range of 1.5 to 6.5 Newton meters.

If there are multiple diameters amongst the plurality of screw holes 13, then the at least one tap comprises a first tap and at least one subsequent tap. The first tap is attached to the machine drill and used to tap the plurality of screw holes 13 having a first diameter.

Each of the at least one subsequent tap is then attached to the machine drill and used to tap the plurality of screw holes 13 having a second diameter, third diameter, etc.

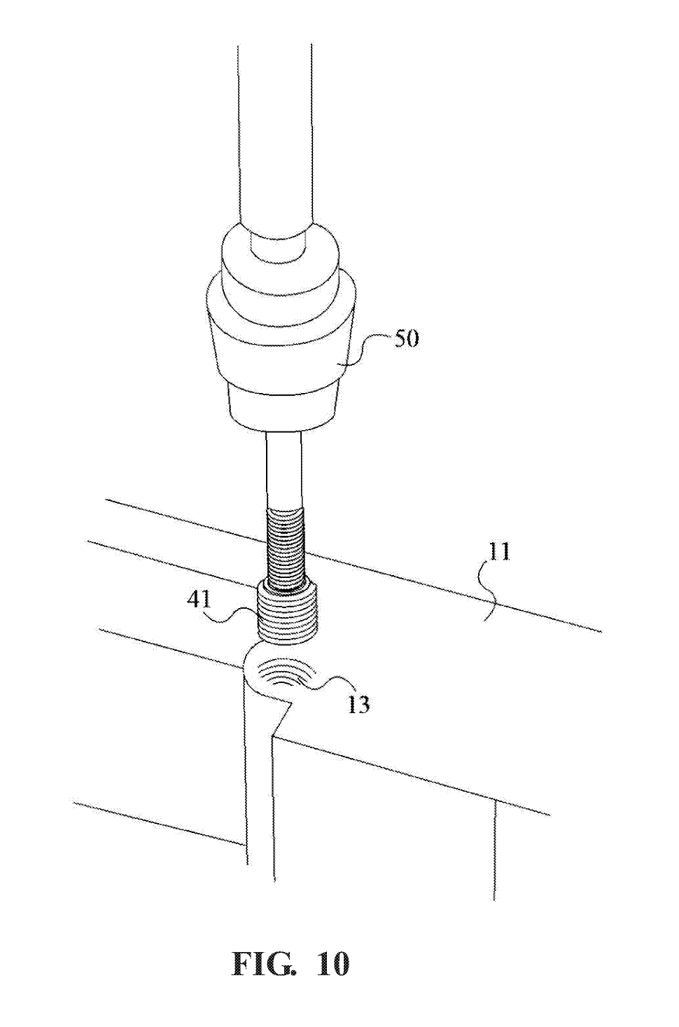

After each of the plurality of screw holes 13 has been tapped, the plurality of machine screw inserts 41 can be inserted into the plurality of screw holes 13. In reference to FIG. 9-10, each of the plurality of machine screw inserts 41 is a tubular extrusion having a threaded outer surface 42 and a threaded inner surface 43. The threaded outer surface 42 is designed to interface with the new threading in the plurality of screw holes 13, while the threaded inner surface 43 is designed to interface with the plurality of screws. In the preferred embodiment of the present invention, each of the plurality of machine screw inserts 41 is constructed from metal, however, it is possible for the plurality of machine screw inserts 41 to be constructed from any other durable material.

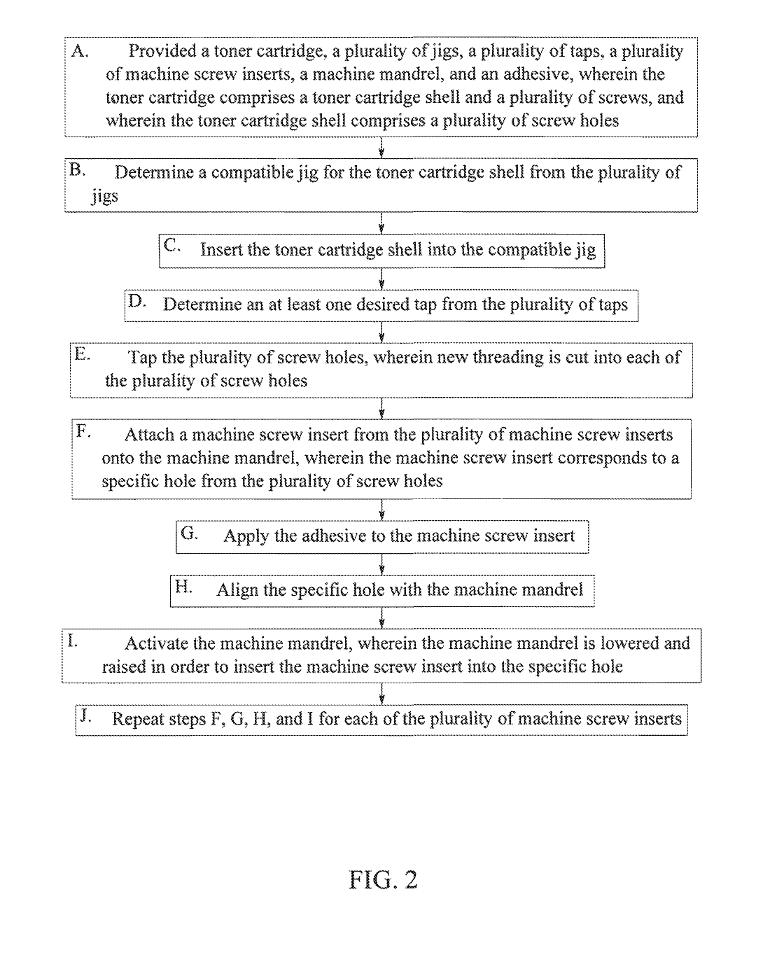

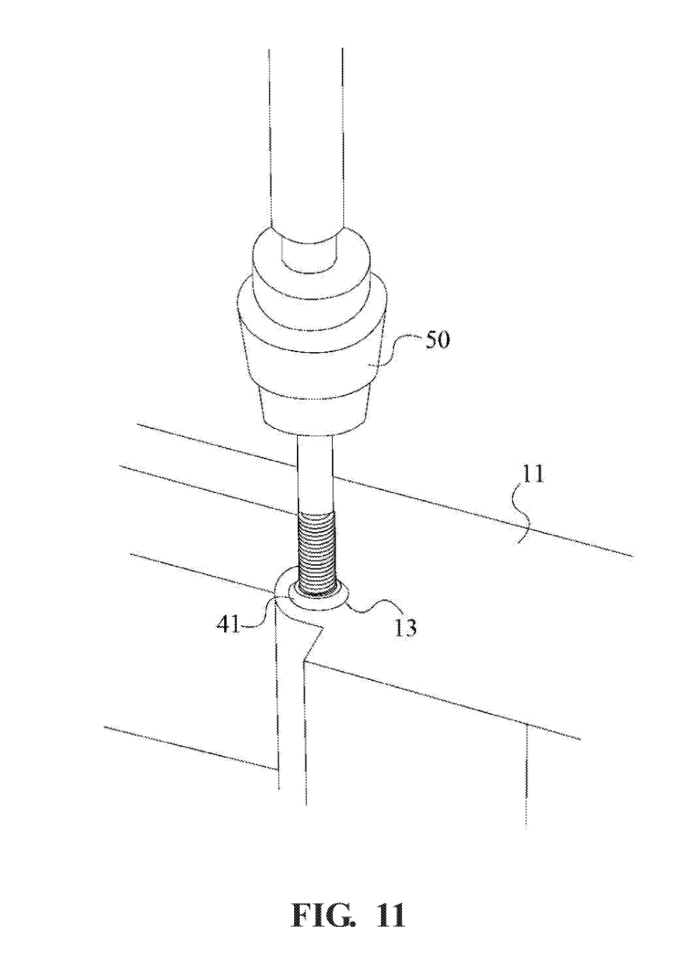

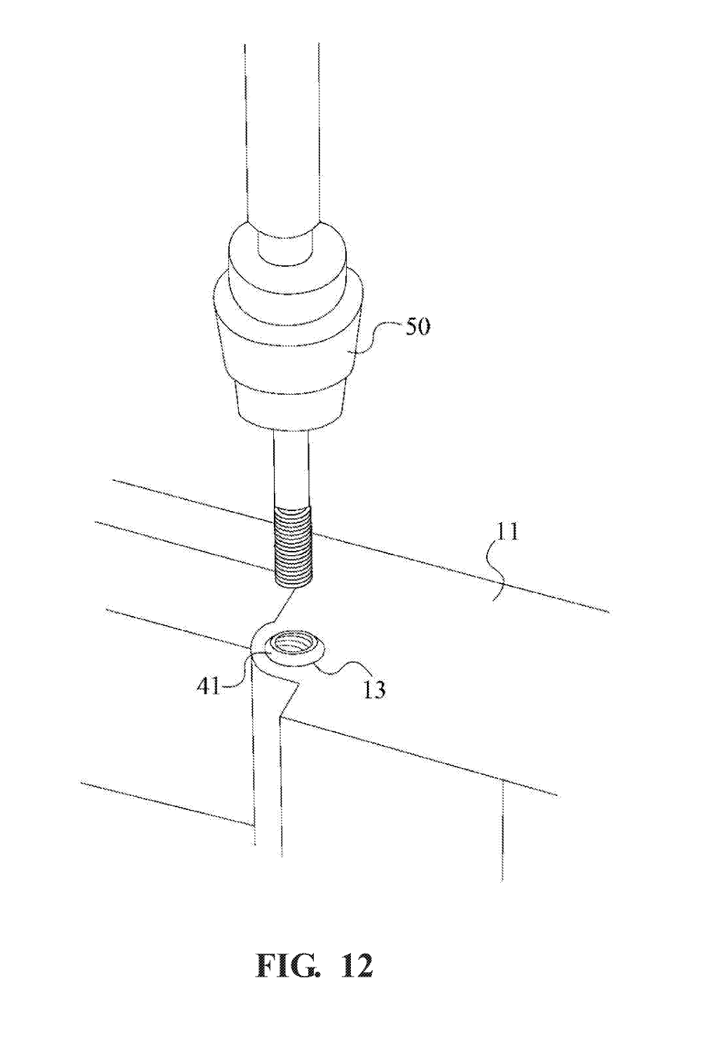

In order to insert the plurality of machine screw inserts 41, a machine mandrel 50 is provided and attached to the drilling machine. In reference to FIG. 2 and FIG. 11, a machine screw insert 41 is selected from the plurality of machine screw inserts 41 and attached to the machine mandrel 50, wherein the machine screw insert 41 corresponds to a specific hole 13 from the plurality of screw holes 13. An adhesive 60 is then applied to the machine screw insert 41, and the specific hole 13 is aligned with the machine mandrel 50. The machine mandrel 50 is then activated and the machine screw insert 41 is inserted into the specific hole 13, as shown in FIG. 12, wherein the threaded outer surface 42 of the machine screw insert 41 engages the new threading of the specific hole 13 in order to retain the machine screw insert 41 within the specific hole 13. The adhesive 60 acts to further secure the machine screw insert 41 within the specific hole 13 once the adhesive 60 is provided time to dry.

When the machine mandrel 50 is activated, the machine mandrel 50 is spun in a first direction in order to insert the machine screw insert 41 into the specific hole 13. The machine mandrel 50 is then lowered into the screw hole, wherein the machine screw insert 41 is inserted into the specific hole 13, as shown in FIG. 12. Upon reaching the depth of the specific hole 13, the machine mandrel 50 is stopped and then spun in a second direction opposite the first direction. As the machine mandrel 50 is spun in the second direction, the machine mandrel 50 is raised out of the specific hole 13, wherein the machine screw insert 41 is retained within the specific hole 13.

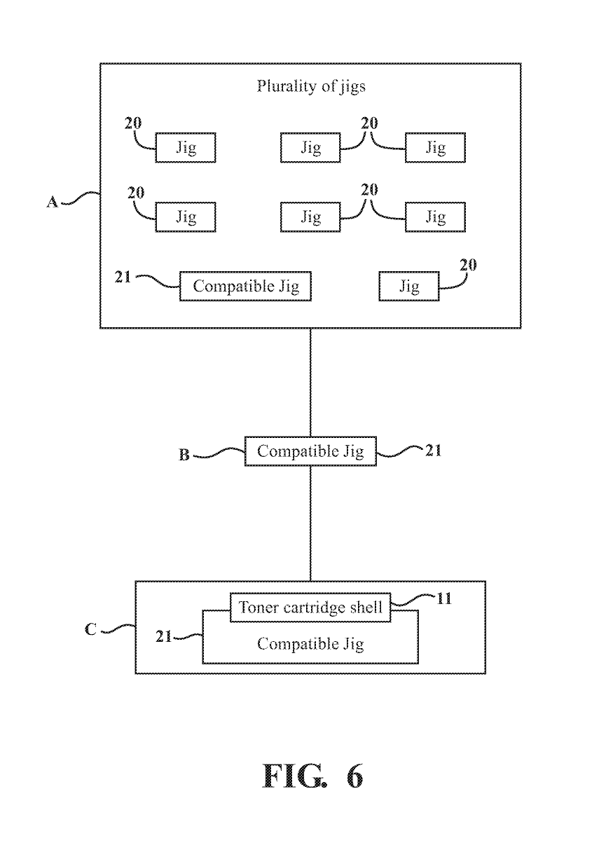

In reference to FIG. 3, both an insertion speed and a removal speed for spinning the machine mandrel 50 in the first direction and the second direction, respectively, are set into the drilling machine before the plurality of machine screw inserts 41 is attached to the machine mandrel 50. In the preferred embodiment of the present invention, the insertion speed is less than 300 revolutions per minute, while the removal speed is approximately half that of the insertion speed, as shown in FIG. 6. Additionally, the machine mandrel 50 is spun in both the first direction and the second direction at low torque in order to ensure that the machine screw is properly engaged with and secured in the specific hole 13.

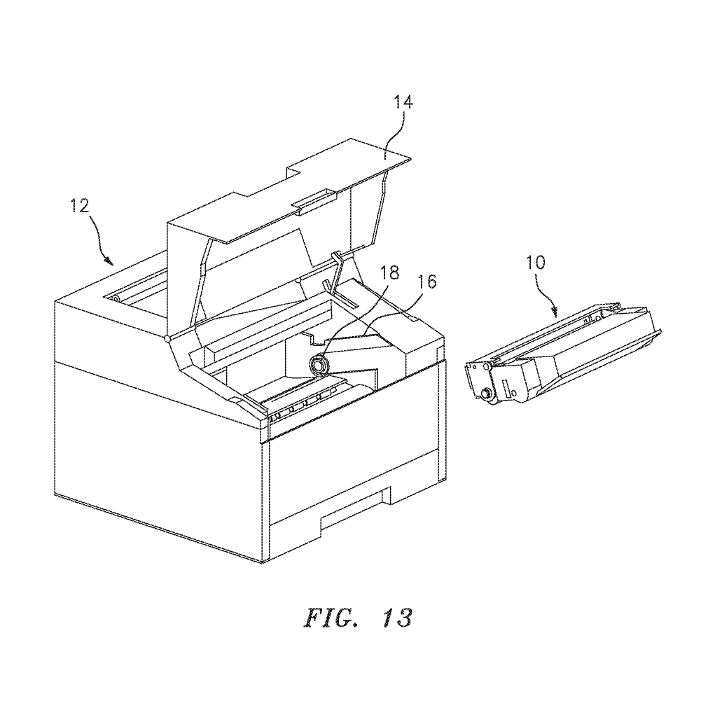

FIG. 13, illustrates a perspective view of the cartridge 10 and an image forming apparatus, such as a laser printer 12. A door 14 is configured for mounting and demounting the cartridge 10. As shown in FIG. 13, the apparatus main assembly 12 includes the door 14. In a state in which the door 14 is opened, the cartridge 10 can be mounted into and demounted from the image forming apparatus 12 along a guide rail 16. When the cartridge 10 is mounted, a driving shaft 18 to be driven by a motor (not shown) of the apparatus main assembly 12 engaged with a drum drive 19 provided on the cartridge 10. As a result, the photosensitive drum connected with the drum drive 19 is rotated by receiving a driving force from the apparatus main assembly 12.

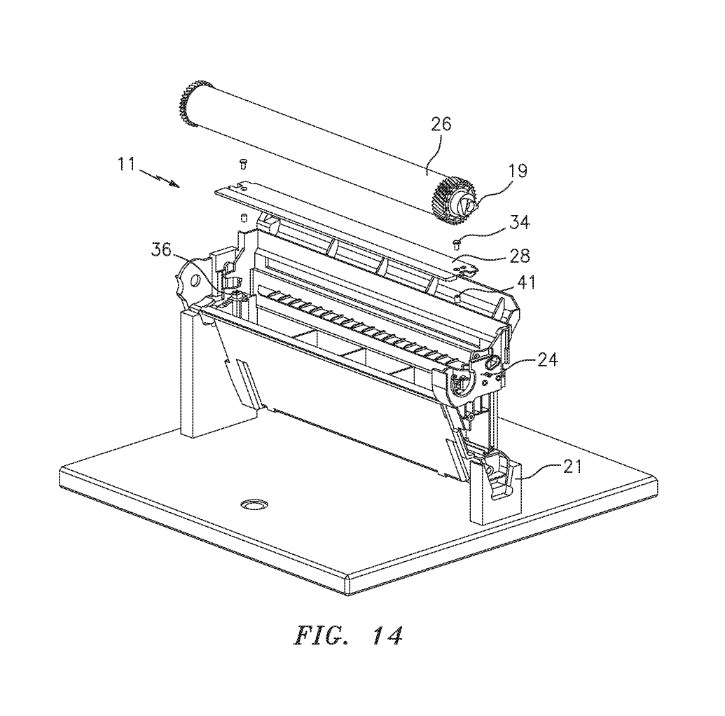

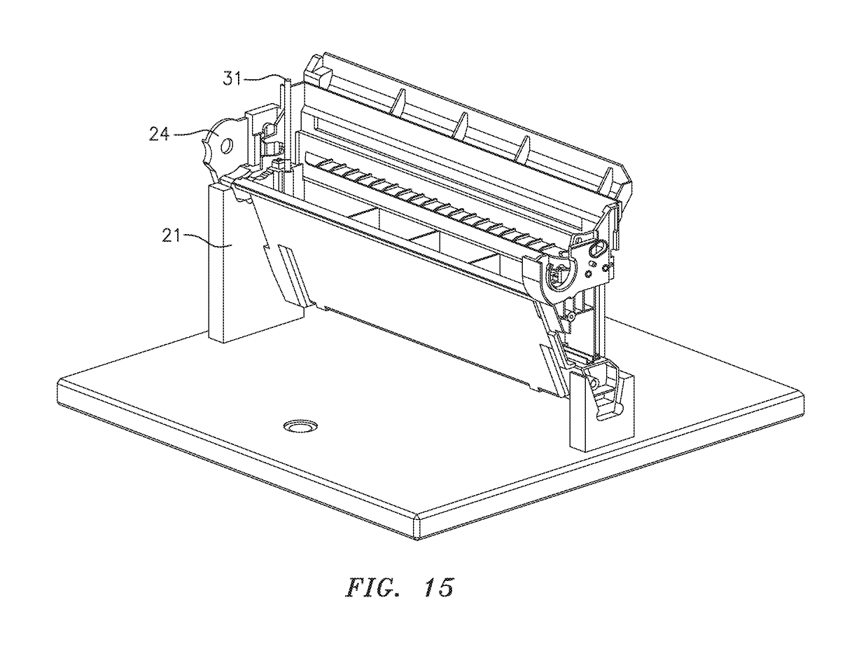

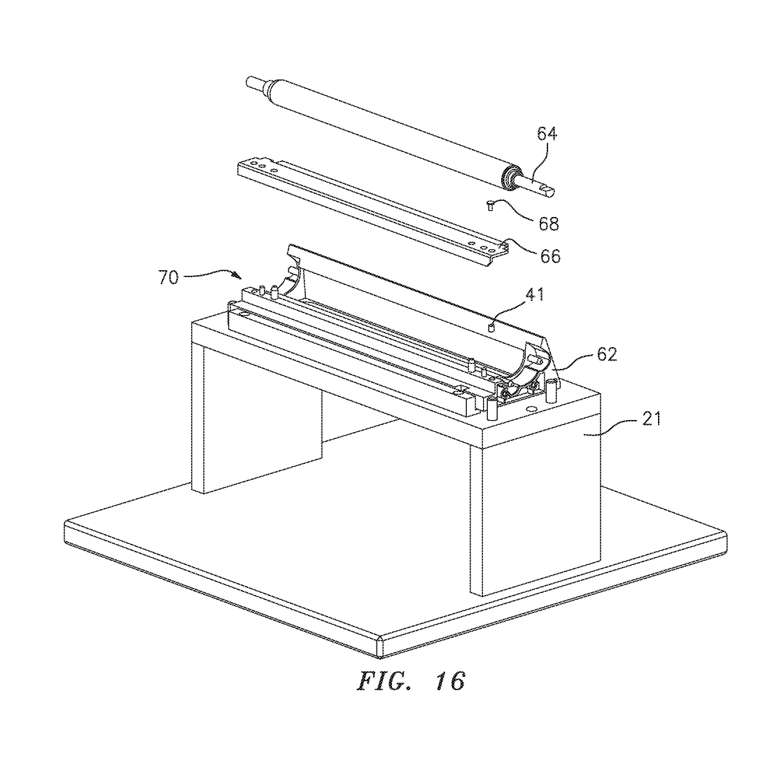

Referring to FIGS. 14 and 15 the cartridge shell 11 is shown mounted in a compatible jig 21. In this embodiment shown, the cartridge shell 11 is a wastebin portion 24. Included with the wastebin 24 is a drum 26 with drum drive 19 configured to be inserted into the wastebin 24. The wastebin 24 includes a wiper blade 28 that cooperates with the drum 26. At least one wiper blade screw 34 fastens the wiper blade 28 to the wastebin 24 at specific wiper blade screw locations 36 on the wastebin 24. The wiper blade screw 34 can correspond to the desired tap 31 and screw insert 41 described above. The importance of inserting the screw insert 41 at the wiper blade screw locations 36 is realized, due to the criticality of securing the wiper blade 28 against being dislodged. The wiper blade 28 undergoes forces during operation of the drum 26 that can cause the wiper blade 28 to dislodge, if not properly secured to the wastebin 24. After being remanufactured, the original screw holes 36 of the wiper blade 28 have the potential to become worn or distorted, such that the screw 34 may not properly secure the wiper blade 28. Installing the screw insert 41 at the key specific wiper blade screw locations 36 ensures adequate wiper blade 28 mounting.

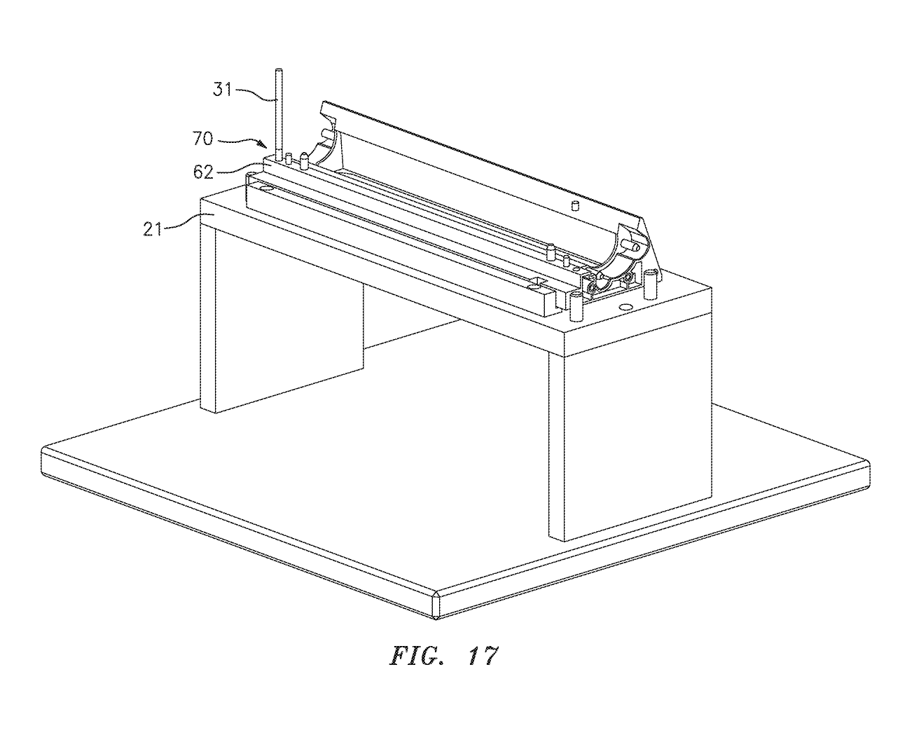

FIGS. 16 and 17 show a hopper 62 portion of the cartridge 10. The hopper 62 is shown mounted in a jig 21 compatible with the particular hopper 62. Mounted to the hopper 62 is a magnetic roller 64. A doctor blade 66 is also mounted to the hopper 62 and secured to the hopper with at least one doctor blade screw 68 at doctor blade screw locations 70. The doctor blade screw 68 can correspond to the desired tap 31 and screw insert 41 described above. The importance of inserting the screw insert 41 at the doctor blade screw locations 70 is realized, due to the criticality of securing the doctor blade 66 against being dislodged. The doctor blade 66 undergoes forces during operation of the magnetic roller 64 that can cause the doctor blade 66 to dislodge, if not properly secured to the hopper 62. After being remanufactured, the original screw holes 70 of the doctor blade 66 have the potential to become worn or distorted, such that the screw 68 may not properly secure the doctor blade 66. Installing the screw insert 41 at the key specific doctor blade screw locations 70 ensures adequate doctor blade 66 mounting.

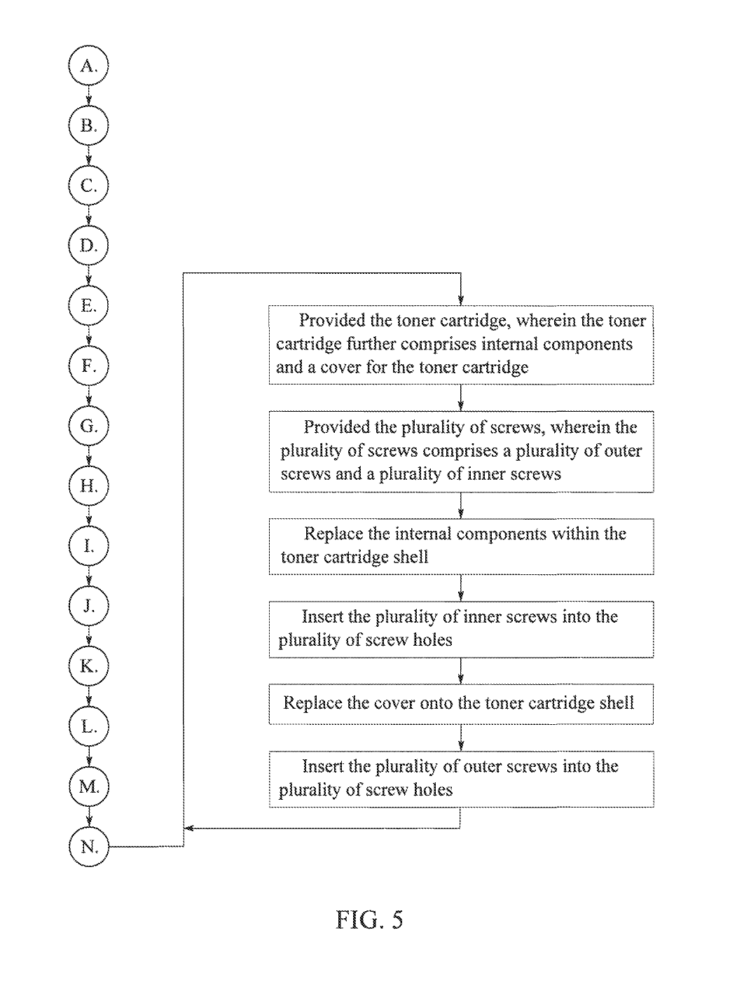

The steps described above for inserting the machine screw insert 41 into the specific hole 13 are then repeated for each of the plurality of machine screw inserts 41 until the plurality of screw holes 13 has been retrofitted. In reference to FIG. 3 and FIG. 5, once each of the plurality of machine screw inserts 41 has been installed, the toner cartridge 10 can be reassembled. Each of the internal components is replaced within the toner cartridge shell 11 and the plurality of inner screws is inserted into the plurality of screw holes 13, wherein the plurality of inner screws engages the plurality of machine screws. The toner cartridge shell 11 is then filled with new toner, the cover is replaced onto the toner cartridge shell 11, and the plurality of outer screws is inserted into the plurality of screw holes 13, wherein the plurality of outer screws engages the plurality of machine screws.

It is an object of the present invention to provide a method of remanufacturing used laser printer toner cartridges without compromising the quality and structural integrity of the toner cartridges themselves. As each of the plurality of screws of a toner cartridge 10 is removed and reinstalled during the disassembly and reassembly processes of remanufacturing, the plurality of screw holes 13 of the toner cartridge shell 11 that has been remanufactured multiple times typically becomes worn as the old plastic threading is stripped. The stripped screw holes result in unreliable fasteners that can potentially lead to problems with both the toner cartridge 10 and the laser printer. The plurality of machine screw inserts 41 of the present invention serve as protective supports for the plurality of screw holes 13 that retains the plurality of screws, without stripping the threading from the plurality of screw holes 13. This allows laser printer toner cartridges to be reused multiple times while maintaining the overall quality of the cartridges and avoiding issues resulting from stripped screw holes. In addition to improving reliability of the fasteners used to assemble the toner cartridges, the present invention reduces the potential for the toner cartridge 10 to cause hardware problems for the laser printer. It is a further object of the present invention to minimize financial costs related to purchasing laser printer toner cartridges. It is generally known that remanufacturing the toner cartridge 10 when empty is a much more cost effective option than purchasing a brand new toner cartridge. Additionally, by reducing the likelihood of the toner cartridge 10 causing hardware problems for a laser printer, potential maintenance and repair costs are lowered as well. Empty toner cartridges are often improperly discarded resulting in environmental ramifications. Improving the overall laser printer toner cartridge remanufacturing process serves as a further incentive to remanufacture empty cartridges.

Although the invention has been explained in relation to its preferred embodiment, it is to be understood that many other possible modifications and variations can be made without departing from the spirit and scope of the invention as hereinafter claimed.

What is claimed is:

1. A method for remanufacturing toner cartridges comprises the steps of:
placing a toner cartridge shell in a jig;
tapping at least one of a wiper blade screw hole and a doctor blade screw hole in said toner cartridge shell;
said tapping step comprising cutting new threading into at least one wiper blade screw hole and at least one doctor blade screw hole; and
inserting a machine screw insert into each of the at least one wiper blade screw hole and doctor blade screw hole.

2. The method of claim 1, further comprising removing a plurality of screws from the at least one wiper blade screw hole and the at least one doctor blade screw hole prior to said tapping step.

3. The method of claim 1, wherein said inserting step comprises inserting a machine screw insert having a threaded outer surface and a threaded inner surface.

4. The method of claim 3, further comprising interfacing said threaded outer surface of said machine screw insert with said new threading in one of said at least one wiper blade screw hole and said at least one doctor blade screw hole.

5. The method of claim 3, further comprising interfacing the threaded inner surface with a screw.

6. The method of claim 3, further comprising applying an adhesive to the machine screw insert to secure said machine screw insert into at least one of said at least one wiper blade screw hole and said at least one doctor blade screw hole.

7. The method of claim 1, wherein said machine screw inserting step comprises attaching a machine mandrel to a drilling machine and attaching said machine screw insert to said machine mandrel.

8. The method of claim 7, further comprising activating said machine mandrel to insert said machine screw insert into one of said at least one wiper blade screw hole and said at least one doctor blade screw hole.

9. The method of claim 8, wherein said activating step comprises spinning the machine mandrel in a first direction in order to insert the machine screw insert into the one of said at least one wiper blade screw hole and said at least one doctor blade screw hole and then spinning said machine mandrel in a second direction opposite said first direction to raise said machine mandrel out of said at least one wiper blade screw hole and at least one doctor blade screw hole while said machine screw insert is retained in said one of said at least one wiper blade screw hole and said at least one doctor blade screw hole.

10. A toner cartridge comprising:
a toner cartridge shell;
said toner cartridge shell having at least one wiper blade screw hole and at least one doctor blade screw hole; and
at least one machine screw insert in said at least one wiper blade screw hole and said at least one doctor blade screw hole.

11. The toner cartridge of claim 10, wherein said at least one machine screw insert comprises a threaded outer surface for contacting said at least one wiper blade screw hole and said at least one doctor blade screw hole and a threaded inner surface.

12. The toner cartridge of claim 11, further comprising a screw contacting said threaded inner surface.

13. The toner cartridge of claim 10, further comprising a plurality of machine screw inserts and one of said plurality of machine screw inserts being located in each of said at least one wiper blade screw hole and said at least one doctor blade screw hole.

14. The toner cartridge of claim 10, further comprising an adhesive applied to the at least one machine screw insert for retaining said at least one machine screw insert in said at least one wiper blade screw hole and said at least one doctor blade screw hole.

15. The toner cartridge of claim 10, further comprising a toner filling said toner cartridge and a cover secured to said toner cartridge shell by an outer screw attached to another at least one machine screw insert.

16. A system for remanufacturing toner cartridges comprises:
a toner cartridge shell having at least one wiper blade screw hole and at least one doctor blade screw hole;
a jig compatible with said toner cartridge shell; and
at least one machine screw insert for placement in at least one of said at least one wiper blade screw hole and said at least one doctor blade screw hole.

17. The system of claim 16, further comprising:
a drill; and
a tap attached to said drill,
whereby said drill is operated to tap said at least one wiper blade screw hole and said at least one doctor blade screw hole.

18. The system of claim 17, further comprising:
a machine mandrel attached to said drill; and
said at least one machine screw insert being attached to said machine mandrel,
whereby said machine mandrel is operated to insert said at least one machine screw insert into at least one of said at least one wiper blade screw hole and said at least one doctor blade screw hole.

19. The system of claim 16, further comprising:
an adhesive for securing said at least one machine screw insert in said at least one wiper blade screw hole and said at least one doctor blade screw hole, said adhesive being applied to said at least one machine screw insert.

20. The system of claim 16, further comprising:
a plurality of machine screw inserts; and
one of said plurality of machine screw inserts being inserted into each one of said at least one wiper blade screw hole and said at least one doctor blade screw hole.
